(19) United States
(12) Patent Application Publication
(10) Pub. No.: US 2015/0073835 A1
(43) Pub. Date: Mar. 12, 2015

(54) SYSTEM AND METHOD FOR GENERATING AN INSURANCE QUOTE OF A PROPERTY IN REAL-TIME

(71) Applicant: Tata Consultancy Services Limited, Mumbai (IN)

(72) Inventor: Anand Sivagnanam, San Antonio, TX (US)

(73) Assignee: Tata Consultancy Services Limited, Mumbai (IN)

(21) Appl. No.: 14/023,487

(22) Filed: Sep. 11, 2013

(51) Int. Cl. G06Q 40/08

(52) U.S. Cl. CPC G06Q 40/08
USPC 705/4

(57) ABSTRACT

The present subject matter described herein, in general, relates to insurance, and more particularly to a system and method for generating an insurance quote of a property in real-time. In one embodiment, a real-time insurance quote generation method is disclosed, comprising: obtaining a user selection, via a single action, of a property displayed on a map via a user interface of a device; determining an address of the property using at least geo co-ordinate details; collating data associated with the property from a plurality of data sources; assessing one or more risk factors associated with the property and underwriting the property based upon the data; computing, via a processor, an insurance quote for the property by using at least one of the data or the one or more risk factors; and providing the insurance quote.

### TECHNICAL FIELD

The present subject matter described herein, in general, relates to insurance, and more particularly to a system and method for generating an insurance quote of a property in real-time.

### BACKGROUND

An insurance quote may be provided to a user through multiple channels by insurance companies, after collecting diverse data from various mediums. The generation of an insurance quote can require assessment of a large amount of data.

The data collection can occur via various mediums like self-servicing web pages, voice-based data collection, manual data collection, representative-utilized data collection, barcodes, QR codes, and OCR based data collection systems. Also, in order to generate the insurance quote, the user may have to input data manually through multiple forms. Current insurance quote generation applications may involve significant human interaction and intervention.

### SUMMARY

This summary is provided to introduce example aspects related to systems and methods for generating insurance quote of a property in real-time and the example aspects are further described below in the detailed description. This summary is not intended to identify essential features of the claimed subject matter nor is it intended for use in determining or limiting the scope of the claimed subject matter.

In one embodiment, a real-time insurance quote generation system is disclosed, comprising: a processor; and a memory storing processor-executable instructions comprising instructions for: obtaining a user selection, via a single action, of a property displayed on a map via a user interface of a device; determining an address of the property using at least geo co-ordinate details; collating data associated with the property from a plurality of data sources; assessing one or more risk factors associated with the property and underwriting the property based upon the data; computing an insurance quote for the property by using at least one of the data or the one or more risk factors; and providing the insurance quote.

In one embodiment, a real-time insurance quote generation method is disclosed, comprising: obtaining a user selection, via a single action, of a property displayed on a map via a user interface of a device; determining an address of the property using at least geo co-ordinate details; collating data associated with the property from a plurality of data sources; assessing one or more risk factors associated with the property and underwriting the property based upon the data; computing, via a processor, an insurance quote for the property by using at least one of the data or the one or more risk factors; and providing the insurance quote.

In one embodiment, a non-transitory computer-readable medium is disclosed, storing computer-executable real-time insurance quote generation instructions comprising instructions for: obtaining a user selection, via a single action, of a property displayed on a map via a user interface of a device; determining an address of the property using at least geo co-ordinate details; collating data associated with the property from a plurality of data sources; assessing one or more risk factors associated with the property and underwriting the property based upon the data; computing an insurance quote for the property by using at least one of the data or the one or more risk factors; and providing the insurance quote.

### BRIEF DESCRIPTION OF THE DRAWINGS

The detailed description is described with reference to the accompanying figures, which are incorporated in and constitute a part of this disclosure. In the figures, the left-most digit(s) of a reference number identifies the figure in which the reference number first appears. The same numbers are used throughout the drawings to refer like features and components.

FIG. 1 illustrates a network implementation of a system for generating an insurance quote of a property in real-time is shown, in accordance with an embodiment of the present subject matter.

FIG. 2 illustrates the system, in accordance with an embodiment of the present subject matter.

FIG. 3 illustrates a method for generating insurance quote of a property in real-time, in accordance with an embodiment of the present subject matter.

### DETAILED DESCRIPTION

Systems and methods for generating insurance quote of a property in real-time are described. In some embodiments, a user may identify a property through a map-based user interface of a device enabled with Global Positioning System (GPS). The map may be loaded with a current location of the device and the user may select any property by panning across the map. Further, address of the property may be determined based on the geo co-ordinate details obtained using Geo Spatial technology.

In some embodiments, data required for generating an insurance quote may be gathered from third party data sources. The third party data sources may comprise third party vendors providing data related to characteristics of the property and vendors providing details related to geographical risks. Further, one or more risk factors may be assessed for the property based on the data. The risk factors and the data both may be used to compute the insurance quote for the property.

While aspects of described system and method for generating an insurance quote of a property in real-time may be implemented in any number of different computing systems, environments, and/or configurations, the embodiments are described in the context of the following exemplary system.

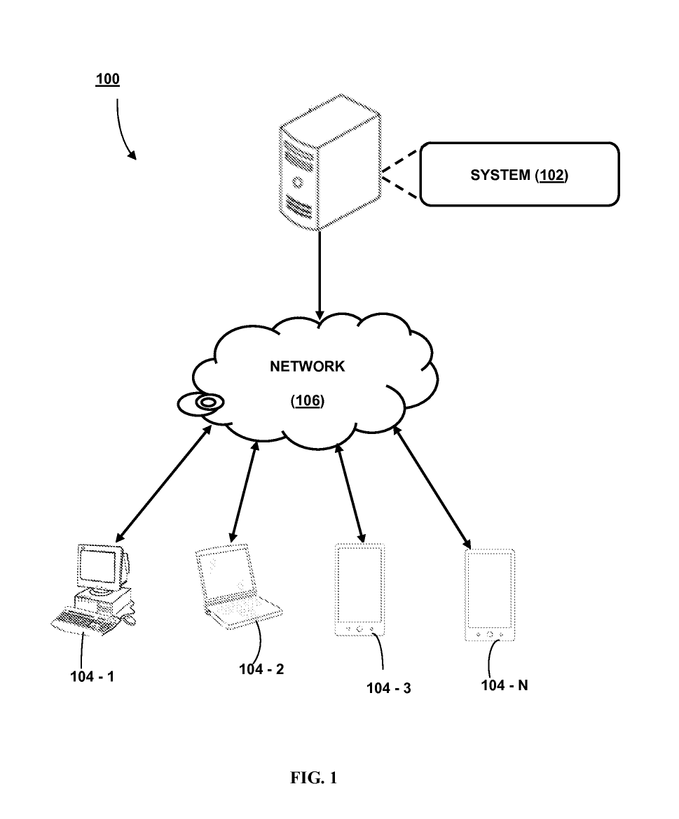

Referring now to FIG. 1, a network implementation 100 of a system 102 for generating an insurance quote of a property in real-time is illustrated, in accordance with an embodiment of the present subject matter. In one embodiment, the system 102 may provide for generating insurance quote of a property in real-time. In one embodiment, the system 102 may allow a user to select the property in a single action on a map displayed with a current location of a device on a user interface of the device. Further, the system 102 may determine an address of the property using at least geo co-ordinate details and collate data associated with the property from a plurality of data sources. The system 102 further may assess one or more risk factors associated with the property, underwrite the property based upon the data, and compute the insurance quote of the property by using at least one of the data and the one or more risk factors.

Although the present subject matter is explained considering that the system 102 is implemented on a server, it is to be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. Additional examples include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. The user devices 104 may be communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

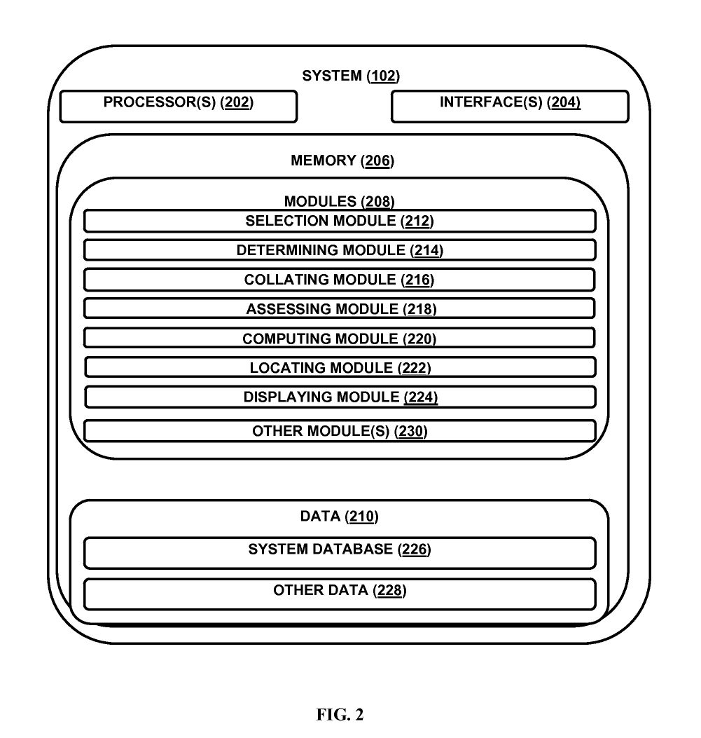

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors (such as AMD Athlon, Duron or Opteron, ARM's application, embedded or secure processors, IBM PowerPC, Intel's Core, Itanium, Xeon, Celeron or other line of processors, etc.), microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206. The at least one processor 202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The I/O interface 204 may include a variety of software and hardware interfaces, for example, a web interface, a graphical user interface, and the like. The I/O interface 204 may allow the system 102 to interact with a user directly or through the client devices 104. A user may include a person, a person using a device such as those included in this disclosure, or such a device itself Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server. The I/O interface 204 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. Additional examples include, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. Memory drives may further include a drum, magnetic disc drive, magneto-optical drive, optical drive, redundant array of independent discs (RAID), solid-state memory devices, solid-state drives, etc.

A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. Examples include random access memory (RAM), read-only memory (ROM), volatile memory, nonvolatile memory, hard drives, CD ROMs, DVDs, flash drives, disks, and any other known physical storage media. The term “computer-readable medium” should be understood to include tangible items and exclude carrier waves and transient signals, i.e., be non-transitory. The memory 206 may store modules 208 and data 210.

The modules 208 may include routines, programs, objects, components, data structures, etc., which perform particular tasks or implement particular abstract data types. In one implementation, the modules 208 may include a selection module 212, a determining module 214, a collating module 216, an assessing module 218, a computing module 220, a locating module 222, a displaying module 224 and other modules 230. The other modules 230 may include programs or coded instructions that supplement applications and functions of the system 102. Such modules may be configured to be executed by the processor 202.

The data 210, amongst other things, may serve as a repository for storing data processed, received, and generated by one or more of the modules 208. The data 210 may also include a system database 226, and other data 228. The other data 228 may include data generated as a result of the execution of one or more modules in the other module 230. Such repositories may be implemented as fault-tolerant, relational, scalable, secure databases such as Oracle or Sybase. Alternatively, such repositories may be implemented using standardized data structures, such as an array, hash, linked list, struct, structured text file (e.g., XML), table, or as object-oriented databases (e.g., using ObjectStore, Poet, Zope, etc.). Such repositories may be consolidated or distributed, sometimes among the various computer systems discussed above in this disclosure. It is to be understood that the structure and operation of any computer or repository may be combined, consolidated, or distributed in any working combination.

In one implementation, at first, a user may use the user device 104 to access the system 102 via the I/O interface 204. The user may register them using the I/O interface 204 in order to use the system 102. The system 102 may be used for generating an insurance quote of a property in real-time. In order to generate the insurance quote of the property in real-time, the system 102 may allow the user to select the property in a single action on a map displayed with a current location of the user device 104 on the user interface 204. Specifically, in some implementations, the user may be allowed to select the property by the selection module 212.

In one implementation, the user device 104 may be one of a cell phone, a smart phone, a personal digital assistant (PDA), a tablet computer, and a similar mobile electronic device in order to allow the user to select the property, the map may be displayed on the user interface 204 of the user device 104. The map may display the current location of the user device 104. The current location of the user device 104 may be identified through Global Positioning System (GPS) if the user device 104 is GPS enabled, else through Internet Protocol (IP) address of the user device 104.

Further, the user may select the property on the map in the single action. The single action may be one of a click, a tap, a touch, a voice command, and gesture. In an alternate embodiment, the user may select any property on the map by performing at least one of panning through the map, zooming in or zooming out on the map, traversing across the map. The user may further select the property via at least one of the click, the tap, the touch, the voice command or the gesture. The system 102 may further comprise a determining module 214 configured to determine an address of the property using at least geo co-ordinate details. The system 102 may further comprise the locating module 222 configured to determine the geo co-ordinate details associated with the property using geo-spatial technology prior to determining the address. In one embodiment, the locating module 222 may be configured to interact with the GPS hardware installed in the user device 104 and the GPS satellites to determine the geo co-ordinate details. The geo co-ordinate details may comprise at least one of latitude, longitude or elevation or a combination thereof, the geo co-ordinate details specifies the property selected.

The determining module 214 may determine the address of the property using reverse geo-coding technology. The determining module 214 may determine the address of the property by converting the geo co-ordinate details to the address of the property. In one embodiment of the invention, the geo co-ordinate details such as latitude, longitude and elevation or a combination thereof may be converted to at least one of a street address, a place name, and an aerial sub-division.

The system 102 may further comprise a collating module 216 configured to collate data associated with the property from a plurality of data sources. The plurality of data sources may comprise at least one of: third party vendors providing details related to characteristics of the property, and vendors providing details related to geographical risks. The details may comprise at least one of: year in which the property is built, no. of stories of the property in case the property is a building of more than one stories, square footage, interior information and exterior information, or a combination thereof. The exterior information may comprise details related to walls, garages & carports, additional structures, attached structures, wings, roof, or security information. The interior information may comprise details related to flooring, interior wall, partition details, rooms, kitchen, bathroom details, fireplace, plumbing, cooling and heating, ceiling type, and sprinkler details and materials used for construction of flooring, interior wall, partition, rooms, kitchen, bathroom, fireplace, plumbing, cooling and heating, ceiling, and sprinkler.

The geographical risks may comprise at least one of coastal risk, storm surge, flood risk, wind and hail risk, earthquake risk, sinkhole, brushfire, lightning risk, and crime risk, or a combination thereof. The data collated may be stored in the system database 226.

The system 102 may further comprise an assessing module 218 configured to assess one or more risk factors associated with the property and underwriting the property based upon the data. In one embodiment, assessing module 218 may use Geographic Information System (GIS) technology to collate and further analyze the data to assess the one or more risk factors associated with the property. The one or more risk factors associated with the property may be assessed based on the risks; location of the property may be exposed to. Risk levels associated with the location may be pre-calibrated with historical data and each location's individual risk may be obtained from the 3^{rd} party vendor for the location. The underwriting of the property may be done based upon the data, the one or more risk factors and underwriting guidelines of a company issuing an insurance policy. The system 102 may further comprise a computing module 220 configured to compute the insurance quote of the property by using at least one of the data and the one or more risk factors. The computing module 220 may be configured to calculate default coverage to state minimum or most sought limits prior to computing of the insurance quote. The calculation of the default coverage may be based on customizable rules. The default coverage may be further used to compute the insurance quote of the property The defaulting logic may be as per the insurance companies product rules and may be majorly based on historical trend and the coverage that may be significantly useful for the location.

The system 102 may further comprise a displaying module 224 configured to display the insurance quote on the user interface 204 of the user device 104.

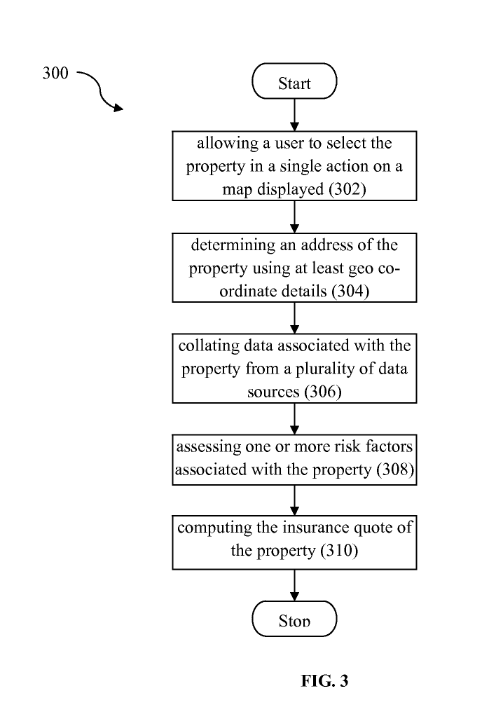

Referring now to FIG. 3, a method 300 for generating an insurance quote of the property in real-time is shown, in accordance with an embodiment of the present subject matter. The method 300 may be described in the general context of computer-executable instructions. Generally, computer-executable instructions can include routines, programs, objects, components, data structures, procedures, modules, functions, etc., that perform particular functions or implement particular abstract data types. The method 300 may also be practiced in a distributed computing environment where functions may be performed by remote processing devices that may be linked through the network 106. In the distributed computing environment, computer-executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof However, for ease of explanation, in the embodiments described below, the method 300 may be considered to be implemented in the above described system 102.

At block 302, a user may be allowed to select a property in a single action on a map displayed with a current location of a user device on a user interface of the device. In one implementation, the user may be allowed to select the property by the selection module 212.

At block 304, an address of the property may be determined using at least geo co-ordinate details. In one implementation, the address of the property may be determined by the determining module 214.

At block 306, data associated with the property may be collated from a plurality of data sources. In one implementation, the data may be collated by the collating module 216.

At block 308, one or more risk factors associated with the property may be assessed and the property may be underwritten based upon the data. In one implementation, one or more risk factors may be assessed by the assessing module 218.

At block 310, the insurance quote of the property may be computed by using at least one of the data and the one or more risk factors. In one implementation, the insurance quote of the property may be computed by the computing module 220.

Although implementations for methods and systems for generating an insurance quote of the property in real-time have been described in language specific to structural features and/or methods, it is to be understood that the appended claims are not necessarily limited to the specific features or methods described. Rather, the specific features and methods are disclosed as examples of implementations for generating an insurance quote of the property in real-time. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It is intended that the disclosure and examples be considered as exemplary only, with a true scope and spirit of disclosed embodiments being indicated by the following claims.

1. A real-time insurance quote generation method, comprising:
obtaining a user selection, via a single action, of a property displayed on a map via a user interface of a device;
determining an address of the property using at least geo co-ordinate details;
collating data associated with the property from a plurality of data sources;
assessing one or more risk factors associated with the property and underwriting the property based upon the data;
computing, via a processor, an insurance quote for the property by using at least one of the data or the one or more risk factors; and
providing the insurance quote.

2. The method of claim 1, wherein the single action is one of: a click, a tap, a touch, a voice command, or a gesture.

3. The method of claim 1, further comprising:
determining the geo co-ordinate details associated with the property using geo-spatial technology prior to determining the address of the property.

4. The method of claim 1, wherein the address of the property is determined using reverse geo-coding technology.

5. The method of claim 1, wherein the plurality of data sources comprise at least one of: third party vendors providing details related to characteristics of the property, or vendors providing details related to geographical risks.

6. The method of claim 1, further comprising:
displaying the insurance quote via the user interface of the device.

7. A real-time insurance quote generation system, comprising:
a processor; and
a memory storing processor-executable instructions comprising instructions for:
obtaining a user selection, via a single action, of a property displayed on a map via a user interface of a device;
determining an address of the property using at least geo co-ordinate details;
collating data associated with the property from a plurality of data sources;
assessing one or more risk factors associated with the property and underwriting the property based upon the data;
computing an insurance quote for the property by using at least one of the data or the one or more risk factors; and
providing the insurance quote.

8. The system of claim 7, wherein the device is one of a cell phone, a smart phone, a personal digital assistant (PDA), a tablet computer, or a mobile electronic device.

9. The systems of claim 7, wherein the single action is one of a click, a tap, a touch, a voice command, or a gesture.

10. The system of claim 7, the instructions further comprising instructions for:
determining the geo co-ordinate details associated with the property using geo-spatial technology prior to determining the address of the property.

11. The system of claim 7, wherein the address of the property is determined using reverse geo-coding technology.

12. The system of claim 7, wherein the plurality of data sources comprise at least one of: third party vendors providing details related to characteristics of the property, or vendors providing details related to geographical risks.

13. The system of claim 7, the instructions further comprising instructions for:
displaying the insurance quote via the user interface of the device.

14. A non-transitory computer-readable medium storing computer-executable real-time insurance quote generation instructions comprising instructions for:
obtaining a user selection, via a single action, of a property displayed on a map via a user interface of a device;
determining an address of the property using at least geo co-ordinate details;
collating data associated with the property from a plurality of data sources;
assessing one or more risk factors associated with the property and underwriting the property based upon the data;
computing an insurance quote for the property by using at least one of the data or the one or more risk factors; and
providing the insurance quote.

15. The medium of claim 14, wherein the device is one of a cell phone, a smart phone, a personal digital assistant (PDA), a tablet computer, or a mobile electronic device.

16. The medium of claim 14, wherein the single action is one of: a click, a tap, a touch, a voice command, or a gesture.

17. The medium of claim 14, the instructions further comprising instructions for:
determining the geo co-ordinate details associated with the property using geo-spatial technology prior to determining the address of the property.

18. The medium of claim 14, wherein the address of the property is determined using reverse geo-coding technology.

19. The medium of claim 14, wherein the plurality of data sources comprise at least one of: third party vendors providing details related to characteristics of the property, or vendors providing details related to geographical risks.

20. The medium of claim 14, the instructions further comprising instructions for:
displaying the insurance quote via the user interface of the device.
